(19) United States
(12) Patent Application Publication
(10) Pub. No.: US 2021/0362733 A1
(43) Pub. Date: Nov. 25, 2021

(54) ELECTRONIC DEVICE FOR VEHICLE AND METHOD OF OPERATING ELECTRONIC DEVICE FOR VEHICLE

(71) Applicant: LG Electronics Inc., Seoul (KR)

(72) Inventors: Sangyol YOON, Seoul (KR); Hyeonju BAE, Seoul (KR); Taekyung LEE, Seoul (KR)

(21) Appl. No.: 16/500,570

(22) PCT Filed: Jan. 11, 2019
(86) PCT No.: PCT/KR2019/000467

§ 371 Date: Oct. 3, 2019

(51) Int. Cl. B60W 50/02; H04W 4/44; H04W 4/46; H04N 17/00; H04N 5/262; B60W 30/14; B60W 50/029; B60R 16/04

(52) U.S. Cl. CPC B60W 50/0205; H04W 4/44; H04W 4/46; H04N 17/002; B60W 2050/0215; B60W 30/143; B60W 50/029; B60R 16/04; B60W 2420/42; H04N 5/2628

(57) ABSTRACT

Disclosed is an electronic device for a vehicle including a power supplier supplying power, an interface exchanging data with a communication device, and a processor receiving external data from at least one external device through the communication device upon determining that at least one of a plurality of sensors has failed and generating data on an object by fusing the external data into sensing data generated by a sensor that has not failed among the plurality of sensors in the state in which the power is supplied to the processor.

### TECHNICAL FIELD

The present invention relates to an electronic device for a vehicle and a method of operating an electronic device for a vehicle.

### BACKGROUND ART

A vehicle is an apparatus that carries a passenger in a direction intended by the passenger. A car is the main example of such a vehicle.

In order to increase the convenience of vehicle users, a vehicle is equipped with various sensors and electronic devices. In particular, an Advanced Driver Assistance System (ADAS) is under active study with the goal of increasing the driving convenience of users. In addition, efforts are being actively made to develop autonomous vehicles.

In order to realize an ADAS and an autonomous vehicle, a plurality of sensors needs to be used to detect objects outside a vehicle. Each of the plurality of sensors is liable to fail temporarily or permanently due to the characteristics thereof or the surrounding environment. When at least one of the plurality of sensors fails, a solution thereto is required.

### DISCLOSURE

### Technical Problem

Therefore, the present invention has been made in view of the above problems, and it is an object of the present invention to provide an electronic device for a vehicle for preparing for the occurrence of failure in at least one of a plurality of sensors.

It is another object of the present invention to provide a method of operating an electronic device for a vehicle for preparing for the occurrence of failure in at least one of a plurality of sensors.

However, the objects to be accomplished by the invention are not limited to the above-mentioned objects, and other objects not mentioned herein will be clearly understood by those skilled in the art from the following description.

### Technical Solution

In accordance with the present invention, the above and other objects can be accomplished by the provision of an electronic device for a vehicle including a power supplier supplying power, an interface exchanging data with a communication device, and a processor receiving external data from at least one external device through the communication device upon determining that at least one of a plurality of sensors has failed and generating data on an object by applying the external data to sensing data generated by a sensor that has not failed among the plurality of sensors in the state in which the power is supplied to the processor.

According to the embodiment of the present invention, upon determining that a camera among the plurality of sensors has failed, the processor may receive image data from at least one of infrastructure or another vehicle through the communication device, and may convert a viewpoint of the received image data into a viewpoint of the vehicle.

According to the embodiment of the present invention, upon determining that a range sensor among the plurality of sensors has failed, the processor may acquire range data from at least one of infrastructure or another vehicle through the communication device, and may convert a viewpoint of the received range data into a viewpoint of the vehicle.

According to the embodiment of the present invention, the processor may set an information request range based on the direction in which a sensor that has failed is oriented, and may transmit an information request signal to at least one first other vehicle located within the set information request range.

According to the embodiment of the present invention, the processor may receive information about a type of a second other vehicle, location information of the second other vehicle, and relative location information of the vehicle and the first other vehicle from the first other vehicle, may estimate the size of the second other vehicle based on the information about the type of the second other vehicle, and may convert the location information of the second other vehicle with respect to the vehicle based on the location information of the second other vehicle and the relative location information.

According to the embodiment of the present invention, the processor may receive motion planning data from the infrastructure through the communication device so as to move to a safety zone.

According to the embodiment of the present invention, the processor may provide a control signal such that the vehicle travels at a speed set according to a type of sensor that has failed among the plurality of sensors.

Details of other embodiments are included in the detailed description and the accompanying drawings.

### Advantageous Effects

According to the present invention, there are one or more effects as follows.

First, even when at least one of a plurality of sensors fails, it is possible to compensate for the failed sensor using external data received from an external device.

Second, even when at least one of a plurality of sensors fails, it is possible to realize an ADAS and an autonomous driving function.

However, the effects achievable through the invention are not limited to the above-mentioned effects, and other effects not mentioned herein will be clearly understood by those skilled in the art from the appended claims.

### DESCRIPTION OF DRAWINGS

FIG. 1 is a view illustrating the external appearance of a vehicle according to an embodiment of the present invention.

FIG. 2 is a view for explaining objects according to the embodiment of the present invention.

FIG. 3 is a block diagram for explaining a vehicle and an electronic device for a vehicle according to the embodiment of the present invention.

FIG. 4 is a block diagram for explaining the electronic device for a vehicle according to the embodiment of the present invention.

FIG. 5 is a flowchart of the electronic device for a vehicle according to the embodiment of the present invention.

FIG. 6 is a view for explaining the operation of the electronic device according to the embodiment of the present invention.

FIG. 7 is a view for explaining the operation of the electronic device according to the embodiment of the present invention.

FIGS. 8a and 8b are views for explaining the operation of the electronic device according to the embodiment of the present invention.

FIG. 9 is a view for explaining the operation of the electronic device according to the embodiment of the present invention.

FIG. 10 is a view for explaining the operation of the electronic device according to the embodiment of the present invention.

### BEST MODE

Reference will now be made in detail to the preferred embodiments of the present invention, examples of which are illustrated in the accompanying drawings. Wherever possible, the same reference numbers will be used throughout the drawings to refer to the same or like parts. As used herein, the suffixes “module” and “unit” are added or interchangeably used to facilitate preparation of this specification and are not intended to suggest unique meanings or functions. In describing embodiments disclosed in this specification, a detailed description of relevant well-known technologies may not be given in order not to obscure the subject matter of the present invention. In addition, the accompanying drawings are merely intended to facilitate understanding of the embodiments disclosed in this specification and not to restrict the technical spirit of the present invention. In addition, the accompanying drawings should be understood as covering all equivalents or substitutions within the scope of the present invention.

Terms including ordinal numbers such as first, second, etc. may be used to explain various elements. However, it will be appreciated that the elements are not limited to such terms. These terms are merely used to distinguish one element from another.

It will be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

The expression of singularity includes a plural meaning unless the singularity expression is explicitly different in context.

It will be further understood that terms such as “include” or “have”, when used in this specification, specify the presence of stated features, integers, steps, operations, elements, components, or combinations thereof, but do not preclude the presence or addition of one or more other features, integers, steps, operations, elements, components, or combinations thereof.

The vehicle described in this specification may conceptually include an automobile and a motorcycle. Hereinafter, description will be given mainly focusing on an automobile.

The vehicle described in this specification may be any of an internal combustion vehicle equipped with an engine as a power source, a hybrid vehicle equipped with an engine and an electric motor as power sources, an electric vehicle equipped with an electric motor as a power source, and the like.

In the description below, the left side of the vehicle means the left side with respect to the direction of travel of the vehicle and the right side of the vehicle means the right side with respect to the direction of travel of the vehicle.

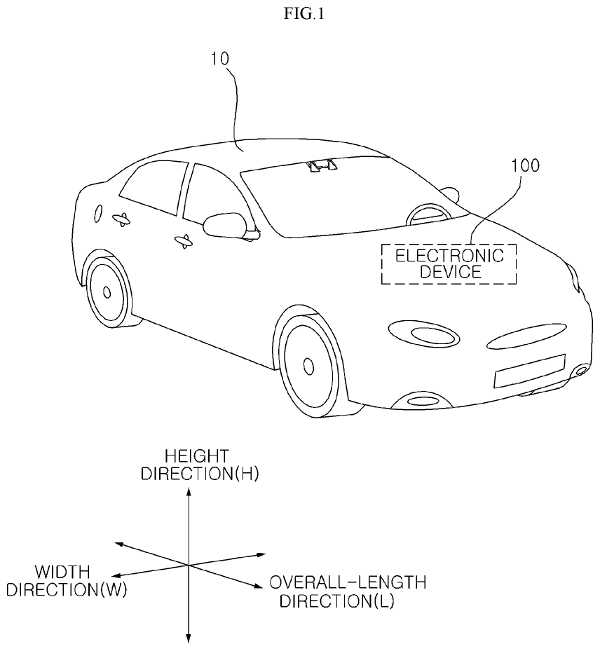

FIG. 1 is a view illustrating the external appearance of a vehicle according to an embodiment of the present invention.

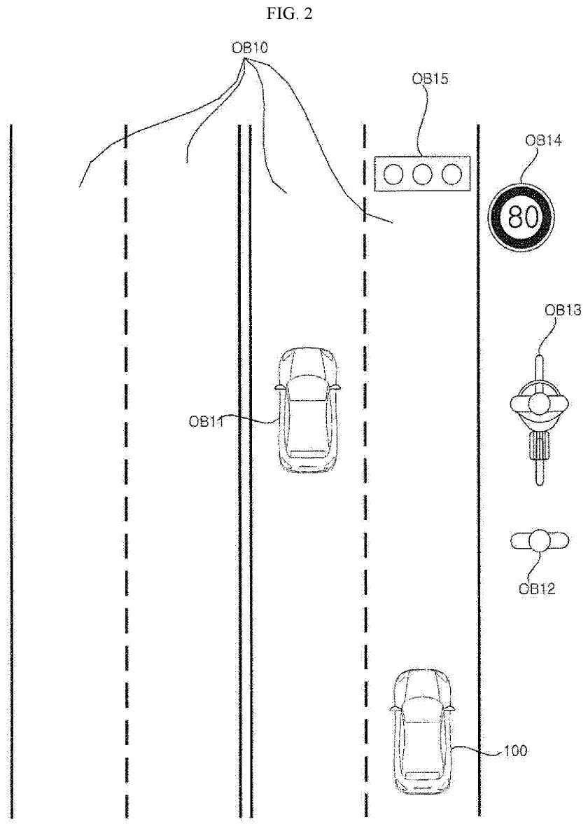

FIG. 2 is a view for explaining objects according to the embodiment of the present invention.

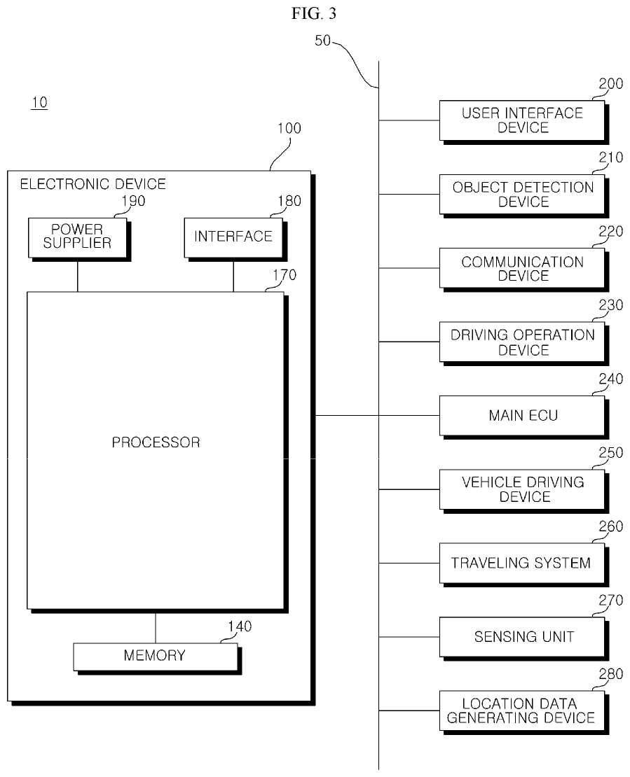

FIG. 3 is a block diagram for explaining a vehicle and an electronic device for a vehicle according to the embodiment of the present invention.

Referring to FIGS. 1 to 3, a vehicle 10 according to an embodiment of the present invention is defined as a transportation means that travels on a road or on rails. The vehicle 10 conceptually encompasses cars, trains, and motorcycles. The vehicle 10 may be any of an internal combustion vehicle equipped with an engine as a power source, a hybrid vehicle equipped with an engine and an electric motor as power sources, an electric vehicle equipped with an electric motor as a power source, and the like.

The vehicle 10 may include a vehicle electronic device 100. The vehicle electronic device 100 may be mounted in the vehicle 10. The vehicle electronic device 100 may set a sensing parameter of at least one range sensor based on the acquired data on objects.

In order to realize the function of an Advanced Driver Assistance System (ADAS) 260, an object detection device 210 acquires data on objects outside the vehicle 10. The data on objects may include at least one of data on the presence or absence of an object, data on the location of an object, data on the distance between the vehicle 10 and an object, or data on the relative speed of the vehicle 10 with respect to an object.

The object may be any of various items related to driving of the vehicle 10.

As illustrated in FIG. 2, objects O may include lanes OB10, another vehicle OB11, a pedestrian OB12, a 2-wheeled vehicle OB13, traffic signals OB14 and OB15, a light, a road, a structure, a speed bump, a geographic feature, an animal, and so on.

The lanes OB10 may include a traveling lane, a lane next to the traveling lane, and a lane in which an oncoming vehicle is traveling. The lanes OB10 may conceptually include left and right lines that define each of the lanes. The lanes may conceptually include a crossroad.

Another vehicle OB11 may be a vehicle traveling in the vicinity of the vehicle 10. Another vehicle may be a vehicle located within a predetermined distance from the vehicle 10. For example, another vehicle OB11 may be a vehicle that precedes or follows the vehicle 10.

The pedestrian OB12 may be a person located in the vicinity of the vehicle 10. The pedestrian OB12 may be a person located within a predetermined distance from the vehicle 10. For example, the pedestrian OB12 may be a person on a sidewalk or a roadway.

The 2-wheeled vehicle OB13 may refer to a transportation means moving on two wheels around the vehicle 10. The 2-wheeled vehicle OB13 may be a transportation means having two wheels, located within a predetermined distance from the vehicle 10. For example, the 2-wheeled vehicle OB13 may be a motorcycle or bicycle on a sidewalk or a roadway.

The traffic signals may include a traffic light device OB15, a traffic sign OB14, and a symbol or text drawn or written on a road surface. The light may be light generated by a lamp of another vehicle. The light may be light generated by a street lamp. The light may be sunlight. The road may include a road surface, a curved road, an inclined road such as an uphill or downhill road, and so on. The structure may be an object fixed on the ground near a road. For example, the structure may include a street lamp, a street tree, a building, a telephone pole, a traffic light device, a bridge, a curb, a wall, and so on. The geographic feature may include a mountain, a hill, and so on.

Objects may be classified into mobile objects and fixed objects. For example, mobile objects may conceptually include another vehicle that is traveling and a pedestrian who is moving. For example, fixed objects may conceptually include a traffic signal, a road, a structure, another vehicle that is not moving, and a pedestrian who is not moving.

The vehicle 10 may include a vehicle electronic device 100, a user interface device 200, an object detection device 210, a communication device 220, a driving operation device 230, a main ECU 240, a vehicle driving device 250, an ADAS application, a sensing unit 270, and a location data generating device 280.

The electronic device 100 may acquire data on an object OB outside the vehicle 10, and may generate a signal for setting a sensing parameter of a range sensor based on the data on the object. The electronic device 100 may include an interface 180, a power supplier 190, a memory 140, and a processor 170.

The interface 180 may exchange signals with at least one electronic device provided in the vehicle 10 in a wired or wireless manner. The interface 180 may exchange signals with at least one of the user interface device 200, the object detection device 210, the communication device 220, the driving operation device 230, the main ECU 240, the vehicle driving device 250, the ADAS application, the sensing unit 270, or the location data generating device 280 in a wired or wireless manner. The interface 180 may be configured as at least one of a communication module, a terminal, a pin, a cable, a port, a circuit, an element, or a device.

The interface 180 may exchange data with the communication device 220. The interface 180 may receive data on objects OB10, OB11, OB12, OB13, OB14 and OB15 outside the vehicle 10 from the communication device 220 mounted in the vehicle 10. The interface 180 may receive data on objects outside the vehicle 10 from the camera mounted in the vehicle 10.

The power supplier 190 may supply power to the electronic device 100. The power supplier 190 may receive power from a power source (e.g. a battery) included in the vehicle 10, and may supply the power to each unit of the electronic device 100. The power supplier 190 may operate in response to a control signal from the main ECU 240. The power supplier 190 may be implemented as a switched-mode power supply (SMPS).

The memory 140 is electrically connected to the processor 170. The memory 140 may store basic data for a unit, control data for controlling the operation of the unit, and input and output data. The memory 140 may store data processed by the processor 170. The memory 140 may be implemented as at least one hardware device selected from among Read-Only Memory (ROM), Random Access Memory (RAM), Erasable and Programmable ROM (EPROM), a flash drive, and a hard drive. The memory 140 may store various data for the overall operation of the electronic device 100, such as programs for processing or control in the processor 170. The memory 140 may be integrated with the processor 170. In some embodiments, the memory 140 may be configured as a lower-level component of the processor 170.

The processor 170 may be electrically connected to the interface 180 and the power supplier 190, and may exchange signals with the same. The processor 170 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electrical units for performing other functions.

The processor 170 may be driven by the power supplied from the power supplier 190. The processor 170 may receive data, process data, generate a signal, and provide a signal in the state in which the power is supplied thereto from the power supplier 190.

The processor 170 may determine whether at least one of a plurality of sensors has failed in the state in which power is supplied thereto. The plurality of sensors may include a camera, a radar, a lidar, an ultrasonic sensor, and an infrared sensor, which are included in the object detection device 210. In some embodiments, some of the camera, the radar, the lidar, the ultrasonic sensor, and the infrared sensor may be omitted from the plurality of sensors.

The processor 170 may determine whether a specific sensor has failed by comparing data on objects acquired by the plurality of sensors with each other. For example, when first sensing data acquired by a first sensor differs from second sensing data acquired by a second sensor or third sensing data acquired by a third sensor by a reference value or more, the processor 170 may determine that the first sensor has failed.

The processor 170 may determine whether a specific sensor has failed based on discontinuous data on an object that is tracked by the specific sensor. For example, when the distance between the object tracked by the first sensor and the vehicle instantaneously exceeds a reference value, the processor 170 may determine that the first sensor has failed.

The processor 170 may determine whether a specific sensor has failed by comparing data on an object received through the communication device 220 with data on the object acquired by the specific sensor.

Upon determining that at least one of the plurality of sensors has failed, the processor 170 may receive external data from at least one external device through the communication device 220 in the state in which power is supplied thereto. The external device may be any one of another vehicle and infrastructure. The infrastructure may be a server or a road side unit (RSU), which constitutes a traffic-related system. The external data may be sensing data acquired by a sensor provided in the external device.

Upon determining that a camera among the plurality of sensors has failed, the processor 170 may receive image data from at least one of the infrastructure or another vehicle through the communication device 220. The processor 170 may convert the received image data into a viewpoint of the vehicle. For example, the processor 170 may convert the received image data into a viewpoint of the vehicle based on data on the positional relationship between the vehicle 10 and at least one of the infrastructure or another vehicle.

The image data converted into a viewpoint of the vehicle may be described as image data converted into a viewpoint in which the outside (e.g. the front area) is visible from the vehicle 10. The infrastructure may capture an image of the surroundings of the vehicle 10 using a camera provided in the infrastructure and may provide the captured image to the vehicle 10. The other vehicle may capture an image of the surroundings of the vehicle 10 using a camera provided in the other vehicle and may provide the captured image to the vehicle 10.

Upon determining that a range sensor among the plurality of sensors has failed, the processor 170 may acquire range data converted into a viewpoint of the vehicle 10 from at least one of the infrastructure or the other vehicle through the communication device 220. The processor 170 may convert the received range data into a viewpoint of the vehicle. For example, the processor 170 may convert the received range data into a viewpoint of the vehicle based on data on the positional relationship between the vehicle 10 and at least one of the infrastructure or the other vehicle.

The range sensor may be understood to be a sensor that generates data on objects using at least one of a Time-of-Flight (ToF) scheme, a structured light scheme, or a disparity scheme. The range sensor may include at least one of a radar, a lidar, an ultrasonic sensor, or an infrared sensor, which is included in the object detection device 210. The range data converted into a viewpoint of the vehicle may be described as range data converted into a viewpoint in which the outside (e.g. the front area) is visible from the vehicle 10. The range data may be data including at least one of location information of an object, distance information thereof, or speed information thereof with respect to the vehicle 10. The infrastructure may sense the surroundings of the vehicle 10 using a range sensor provided in the infrastructure and may provide range data to the vehicle 10. The other vehicle may sense the surroundings of the vehicle 10 using a range sensor provided in the other vehicle and may provide range data to the vehicle 10.

The processor 170 may set an information request range. The processor 170 may set an information request range based on the travel speed of the vehicle 100. For example, when the vehicle travels at a high speed, the processor 170 may set a wider information request range in the heading direction of the vehicle 100 than when the vehicle travels at a low speed. The processor 170 may set an information request range based on the direction in which the sensor that has failed is oriented. For example, when the sensor that has failed is mounted so as to be oriented in the forward direction of the vehicle 100, the processor 170 may set a front area of the vehicle 100 to be an information request range.

The processor 170 may transmit an information request signal to another vehicle located within the set information request range through the communication device 220. For example, when the front area of the vehicle 100 is set to be the information request range, the processor 170 may transmit an information request signal to another vehicle located within a predetermined distance from the vehicle 100 in the forward direction.

The processor 170 may receive information about an object (e.g. another vehicle) through the communication device 220. The information about the object may include information about the location of the object and information about the type of the object. For example, the information about the type of the object may include information about the type of a lane, which is classified as an object, or information about the type of another vehicle (e.g. a sedan, a bus, or a truck), which is classified as an object. Based on information about the type of another vehicle classified as an object, the processor 170 may estimate the size of the other vehicle.

The processor 170 may receive location information of another vehicle transmitting information. For example, the processor 170 may receive coordinate information and direction information of the other vehicle transmitting information. The processor 170 may further receive information about the location of the other vehicle transmitting information relative to the vehicle 100. Based on the location information of the other vehicle classified as an object and the information about the location of the other vehicle transmitting information relative to the vehicle 100, the processor 170 may convert the information about the location of the other vehicle classified as an object with respect to the vehicle 100. If there is infrastructure, the processor may receive data on the infrastructure as well as the information about the object.

The processor 170 may generate data on the object by fusing external data into sensing data generated by a sensor that has not failed among the plurality of sensors.

The processor 170 may receive motion planning data from the infrastructure through the communication device 220 so as to move to a safety zone. The processor 170 may compare the sensing data with external data. The processor 170 may determine whether the size of an error between the external data and the sensing data is greater than or equal to a reference value. Upon determining that the size of an error between the external data and the sensing data is greater than or equal to a reference value, the processor 170 may receive motion planning data from the infrastructure through the communication device 220 so as to move to the safety zone. The safety zone may be defined as a zone in a road in which the safety of the passenger in the vehicle 10 is secured and the vehicle 10 does not disturb the travel of another vehicle.

Based on the data on the object, the processor 170 may generate motion planning data, based on which the vehicle 10 moves to the safety zone. The processor 170 may provide motion planning data to other electronic devices in the vehicle.

The processor 170 may provide a control signal such that the vehicle 10 travels at a speed set according to the type of sensor that has failed among the plurality of sensors. For example, when the camera fails and the range sensor operates normally, the vehicle 10 may be set to travel at 80% or less of the speed limit of the road. For example, when the camera operates normally and the range sensor fails, the vehicle 10 may be set to travel at 60 km/h or less. For example, when both the camera and the range sensor fail, the vehicle 10 may be set to travel at 40 km/h or less.

Hereinafter, the case in which the camera fails and the case in which the range sensor fails will be described individually.

1. Case in which the Camera Fails

Image data necessary for the vehicle 10 may be regenerated by recognizing the relative location of a neighboring vehicle and combining the image data of the neighboring vehicle using at least one of the range sensor or the location data generating device 280 mounted in the vehicle 10.

(1) Case in which a Sufficient Number of Other Vehicles are Present Around the Vehicle when the Camera Fails

1) Case in which there is No Infrastructure

The processor 170 may transmit sensor failure state information to another vehicle located around the vehicle 10 through the communication device 220. The processor 170 may provide a control signal to reduce the travel speed of the vehicle 10. The processor 170 may receive image data generated by another vehicle located around the vehicle 10 and first location data of the vehicle 10 with respect to the other vehicle through the communication device 220. The processor 170 may acquire second location data of the other vehicle relative to the vehicle 10 based on the data generated by the range sensor. The processor 170 may convert the received image data into a viewpoint of the vehicle 10 based on the first location data and the second location data. The processor 170 may generate image data, which is converted into a viewpoint of the vehicle 10. In an emergency situation, the processor 170 may generate motion planning data for travel to the safety zone and may transmit the motion planning data to the neighboring vehicle through the communication device 220.

2) Case in which there is Infrastructure

The processor 170 may transmit sensor failure state information to the infrastructure and another vehicle located around the vehicle 10 through the communication device 220. The processor 170 may provide a control signal to reduce the travel speed of the vehicle 10. The infrastructure may recognize the location of the vehicle 10, the sensor of which has failed, and may transmit image date from a viewpoint of the vehicle 10 to the vehicle 10. In an emergency situation, the infrastructure may generate motion planning data of the vehicle 10 for travel to the safety zone, and may transmit the generated motion planning data to the vehicle 10 and the other vehicle around the vehicle 10.

(2) Case in which a Sufficient Number of Other Vehicles are not Present Around the Vehicle when the Camera Fails

1) Case in which there is No Infrastructure

The processor 170 may transmit sensor failure state information to another vehicle located around the vehicle 10 through the communication device 220. The processor 170 may provide a control signal to reduce the travel speed of the vehicle 10. The processor 170 may determine whether it is possible to recognize the location of the vehicle 10 based on data received from at least one of the range sensor or the location data generating device 280. Upon determining that it is possible to recognize the location of the vehicle 10, the processor 170 may generate motion planning data for travel to the safety zone, and may transmit the motion planning data to the neighboring vehicle through the communication device 220. Upon determining that it is impossible to recognize the location of the vehicle 10, the processor 170 may provide a control signal to stop the vehicle 10. The processor 170 may continuously transmit sensor failure state information to the neighboring vehicle.

2) Case in which there is Infrastructure

The processor 170 may transmit sensor failure state information to the infrastructure and another vehicle located around the vehicle 10 through the communication device 220. The processor 170 may provide a control signal to reduce the travel speed of the vehicle 10. The infrastructure may recognize the location of the vehicle 10, the sensor of which has failed, and may transmit image date from a viewpoint of the vehicle 10 to the vehicle 10. In an emergency situation, the infrastructure may generate motion planning data of the vehicle 10 for travel to the safety zone, and may transmit the generated motion planning data to the vehicle 10 and the other vehicle around the vehicle 10.

2. Case in which the Range Sensor Fails

(1) Case in which a Sufficient Number of Other Vehicles are Present Around the Vehicle when the Range Sensor Fails

1) Case in which there is No Infrastructure

The processor 170 may transmit sensor failure state information to another vehicle located around the vehicle 10 through the communication device 220. The processor 170 may provide a control signal to reduce the travel speed of the vehicle 10. The processor 170 may receive range data generated by another vehicle located around the vehicle 10 and first location data of the vehicle 10 with respect to the other vehicle through the communication device 220. The processor 170 may convert the received range data into a viewpoint of the vehicle 10 based on the first location data. The processor 170 may generate range data, which is converted into a viewpoint of the vehicle 10. In an emergency situation, the processor 170 may generate motion planning data for travel to the safety zone and may transmit the motion planning data to the neighboring vehicle through the communication device 220.

2) Case in which there is Infrastructure

The processor 170 may transmit sensor failure state information to the infrastructure and another vehicle located around the vehicle 10 through the communication device 220. The processor 170 may provide a control signal to reduce the travel speed of the vehicle 10. The infrastructure may recognize the location of the vehicle 10, the sensor of which has failed, and may transmit image date from a viewpoint of the vehicle 10 to the vehicle 10. In an emergency situation, the infrastructure may generate motion planning data of the vehicle 10 for travel to the safety zone, and may transmit the generated motion planning data to the vehicle 10 and the other vehicle around the vehicle 10.

(2) Case in which a Sufficient Number of Other Vehicles are not Present Around the Vehicle when the Range Sensor Fails

1) Case in which there is No Infrastructure

The processor 170 may transmit sensor failure state information to another vehicle located around the vehicle 10 through the communication device 220. The processor 170 may provide a control signal to reduce the travel speed of the vehicle 10. The processor 170 may determine whether it is possible to recognize the location of the vehicle 10 based on data received from at least one of the camera or the location data generating device 280. Upon determining that it is possible to recognize the location of the vehicle 10, the processor 170 may generate motion planning data for travel to the safety zone, and may transmit the motion planning data to the neighboring vehicle through the communication device 220. Upon determining that it is impossible to recognize the location of the vehicle 10, the processor 170 may provide a control signal to stop the vehicle 10. The processor 170 may continuously transmit sensor failure state information to the neighboring vehicle.

2) Case in which there is Infrastructure

The processor 170 may transmit sensor failure state information to the infrastructure and another vehicle located around the vehicle 10 through the communication device 220. The processor 170 may provide a control signal to reduce the travel speed of the vehicle 10. The infrastructure may recognize the location of the vehicle 10, the sensor of which has failed, and may transmit image date from a viewpoint of the vehicle 10 to the vehicle 10. In an emergency situation, the infrastructure may generate motion planning data of the vehicle 10 for travel to the safety zone, and may transmit the generated motion planning data to the vehicle 10 and the other vehicle around the vehicle 10.

The electronic device 100 may include at least one printed circuit board (PCB). The interface 180, the power supplier 190, the memory 140, and the processor 170 may be electrically connected to the printed circuit board.

The user interface device 200 is a device used to enable the vehicle 10 to communicate with a user. The user interface device 200 may receive user input and may provide information generated by the vehicle 10 to the user. The vehicle 10 may implement a User Interface (UI) or a User Experience (UX) through the user interface device 200.

The object detection device 210 may detect objects outside the vehicle 10. The object detection device 210 may include at least one of a camera, a radar, a lidar, an ultrasonic sensor, or an infrared sensor. The object detection device 210 may provide data on an object, which is generated based on a sensing signal generated by the sensor, to at least one electronic device included in the vehicle.

The object detection device 210 may generate dynamic data based on the sensing signal with respect to the object. The object detection device 210 may provide the dynamic data to the electronic device 100.

The communication device 220 may exchange signals with devices located outside the vehicle 10. The communication device 220 may exchange signals with at least one of infrastructure (e.g. a server) or other vehicles. In order to realize communication, the communication device 220 may include at least one of a transmission antenna, a reception antenna, a Radio-Frequency (RF) circuit capable of implementing various communication protocols, or an RF device.

The driving operation device 230 is a device that receives user input for driving the vehicle. In the manual mode, the vehicle 10 may be driven based on a signal provided by the driving operation device 230. The driving operation device 230 may include a steering input device (e.g. a steering wheel), an acceleration input device (e.g. an accelerator pedal), and a brake input device (e.g. a brake pedal).

The main ECU 240 may control the overall operation of at least one electronic device provided in the vehicle 10.

The vehicle driving device 250 is a device that electrically controls the operation of various devices in the vehicle 10. The vehicle driving device 250 may include a powertrain driving unit, a chassis driving unit, a door/window driving unit, a safety device driving unit, a lamp driving unit, and an air-conditioner driving unit. The powertrain driving unit may include a power source driving unit and a transmission driving unit. The chassis driving unit may include a steering driving unit, a brake driving unit, and a suspension driving unit.

The traveling system 260 may perform the traveling operation of the vehicle 10. The traveling system 260 may provide a control signal to at least one of the powertrain driving unit or the chassis driving unit of the vehicle driving device 250, and may drive the vehicle 10.

The traveling system 260 may include at least one of an ADAS application or an autonomous driving application. The traveling system 260 may generate a driving control signal using at least one of the ADAS application or the autonomous driving application.

The ADAS application may generate a signal for controlling the movement of the vehicle 10 or outputting information to the user based on the data on an object received from the object detection device 210. The ADAS application may provide the generated signal to at least one of the user interface device 200, the main ECU 240, or the vehicle driving device 250.

The ADAS application may implement at least one of Adaptive Cruise Control (ACC), Autonomous Emergency Braking (AEB), Forward Collision Warning (FCW), Lane Keeping Assist (LKA), Lane Change Assist (LCA), Target Following Assist (TFA), Blind Spot Detection (BSD), High Beam Assist (HBA), Auto Parking System (APS), PD collision warning system, Traffic Sign Recognition (TSR), Traffic Sign Assist (TSA), Night Vision (NV), Driver Status Monitoring (DSM), or Traffic Jam Assist (TJA).

The sensing unit 270 may sense the state of the vehicle. The sensing unit 270 may include at least one of an inertial navigation unit (IMU) sensor, a collision sensor, a wheel sensor, a speed sensor, an inclination sensor, a weight detection sensor, a heading sensor, a position module, a vehicle forward/reverse movement sensor, a battery sensor, a fuel sensor, a tire sensor, a steering sensor for detecting rotation of the steering wheel, a vehicle internal temperature sensor, a vehicle internal humidity sensor, an ultrasonic sensor, an illuminance sensor, an accelerator pedal position sensor, or a brake pedal position sensor. The inertial navigation unit (IMU) sensor may include at least one of an acceleration sensor, a gyro sensor, or a magnetic sensor.

The sensing unit 270 may generate data on the state of the vehicle based on the signal generated by at least one sensor. The sensing unit 270 may acquire sensing signals of vehicle attitude information, vehicle motion information, vehicle yaw information, vehicle roll information, vehicle pitch information, vehicle collision information, vehicle heading information, vehicle angle information, vehicle speed information, vehicle acceleration information, vehicle inclination information, vehicle forward/reverse movement information, battery information, fuel information, tire information, vehicle lamp information, vehicle internal temperature information, vehicle internal humidity information, a steering wheel rotation angle, vehicle external illuminance, the pressure applied to the accelerator pedal, the pressure applied to the brake pedal, and so on.

The sensing unit 270 may further include an accelerator pedal sensor, a pressure sensor, an engine speed sensor, an air flow sensor (AFS), an air temperature sensor (ATS), a water temperature sensor (WTS), a throttle position sensor (TPS), a top dead center (TDC) sensor, a crank angle sensor (CAS), and so on.

The sensing unit 270 may generate vehicle state information based on the sensing data. The vehicle state information may be generated based on data detected by various sensors included in the vehicle.

For example, the vehicle state information may include vehicle attitude information, vehicle speed information, vehicle inclination information, vehicle weight information, vehicle heading information, vehicle battery information, vehicle fuel information, vehicle tire air pressure information, vehicle steering information, vehicle internal temperature information, vehicle internal humidity information, pedal position information, vehicle engine temperature information, and so on.

The location data generating device 280 may generate data on the location of the vehicle 10. The location data generating device 280 may include at least one of a global positioning system (GPS) or a differential global positioning system (DGPS). The location data generating device 280 may generate data on the location of the vehicle 10 based on the signal generated by at least one of the GPS or the DGPS. In some embodiments, the location data generating device 280 may correct the location data based on at least one of the inertial measurement unit (IMU) of the sensing unit 270 or the camera of the object detection device 210.

The vehicle 10 may include an internal communication system 50. The electronic devices included in the vehicle 10 may exchange signals via the internal communication system 50. The signals may include data. The internal communication system 50 may use at least one communication protocol (e.g. CAN, LIN, FlexRay, MOST, and Ethernet).

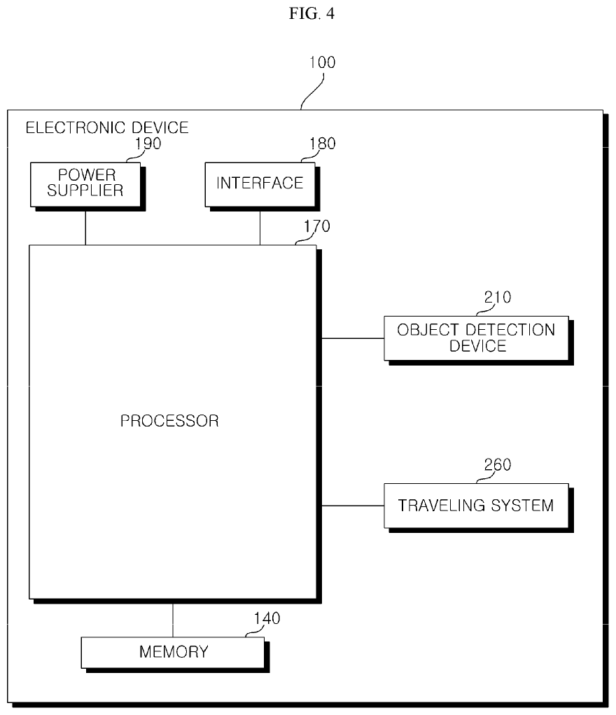

FIG. 4 is a block diagram for explaining the electronic device for a vehicle according to the embodiment of the present invention.

Referring to FIG. 4, the electronic device 100 for a vehicle may further include an object detection device 210 and an ADAS application in an individual manner or a combined manner, unlike the electronic device for a vehicle described with reference to FIG. 3.

The processor 170 of the vehicle electronic device 100 in FIG. 3 exchanges data with the object detection device 210 and the ADAS application through the interface 180, whereas the processor 170 of the vehicle electronic device 100 in FIG. 4 may be electrically connected to the object detection device 210 and the ADAS application to exchange data with the same. In this case, the object detection device 210 and the ADAS application may be electrically connected to the printed circuit board to which the processor 170 is electrically connected.

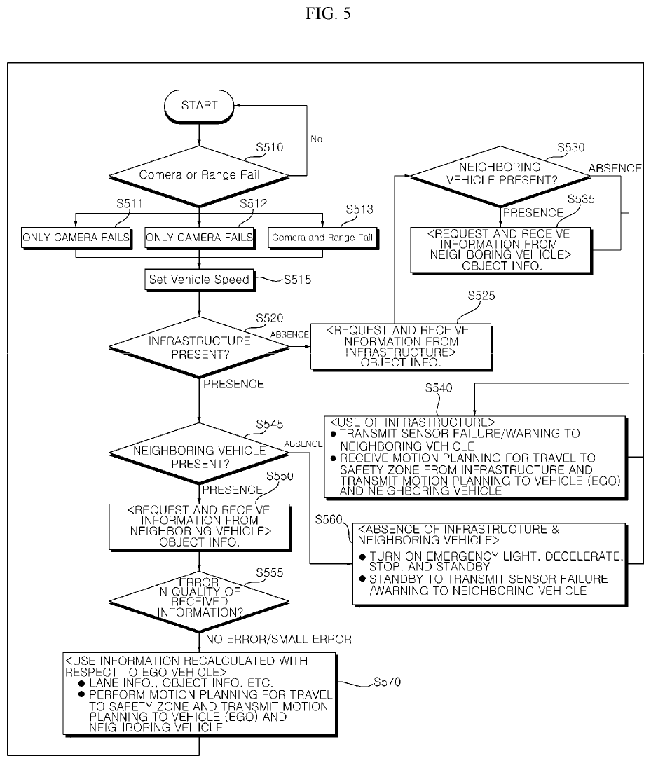

FIG. 5 is a flowchart of the electronic device for a vehicle according to the embodiment of the present invention.

FIG. 5 is a flowchart illustrating a method of operating the electronic device 100 for a vehicle.

Referring to FIG. 5, the processor 170 may determine whether at least one of a plurality of sensors has failed in the state in which power is supplied thereto (S510). The processor 170 may determine whether only the camera has failed (S511), whether only the range sensor has failed (S512), or whether both the camera and the range sensor have failed (S513).

The processor 170 may provide a control signal such that the vehicle 10 travels at a speed set according to the type of sensor that has failed among the plurality of sensors (S515). For example, when the camera fails and the range sensor operates normally, the vehicle 10 may be set to travel at 80% or less of the speed limit of the road. For example, when the camera operates normally and the range sensor fails, the vehicle 10 may be set to travel at a speed at which the processor 170 is capable of capturing an image through the camera and acquiring information required for traveling through the image. The processor 170 may set the vehicle 10 to travel at 60 km/h or less. For example, when both the camera and the range sensor fail, the vehicle 10 may be set to travel at the minimum autonomous driving speed. The processor 170 may set the vehicle 10 to travel at 40 km/h or less.

The processor 170 may receive external data from at least one external device through the communication device 220 upon determining that at least one of the plurality of sensors has failed in the state in which power is supplied thereto (S525, S535, S540 and S550).

When there is infrastructure (S520), the processor 170 may request information from the infrastructure and may receive information (S525). Here, the information may be information about an external object that is generated by the infrastructure and is required for traveling of the vehicle 10. For example, the information may include at least one of image data or range data.

When another vehicle is present around the vehicle 10 (S530), the processor 170 may request information from the other vehicle and may receive information (S525). Here, the information may be information about an external object that is generated by the other vehicle and is required for traveling of the vehicle 10. For example, the information may include at least one of image data or range data.

The processor 170 may transmit sensor failure state information and a warning message to the other vehicle around the vehicle 10 via the infrastructure. The processor 170 may receive motion planning data from the infrastructure. In this case, the motion planning data may also be transmitted to the other vehicle around the vehicle 10 by the infrastructure (S540).

When there is no infrastructure (S520) and when another vehicle is present around the vehicle 10 (S545), the processor 170 may request information from the other vehicle and may receive information (S550). Here, the information may be information about an external object that is generated by the other vehicle and is required for traveling of the vehicle 10. For example, the information may include at least one of image data or range data.

In step S550, the processor 170 may set an information request range. The processor 170 may set an information request range based on the travel speed of the vehicle 100. For example, when the vehicle travels at a high speed, the processor 170 may set a wider information request range in the heading direction of the vehicle 100 than when the vehicle travels at a low speed. The processor 170 may set an information request range based on the direction in which the sensor that has failed is oriented. For example, when the sensor that has failed is mounted so as to be oriented in the forward direction of the vehicle 100, the processor 170 may set a front area of the vehicle 100 to be an information request range.

In step S550, the processor 170 may transmit an information request signal to another vehicle located within the set information request range through the communication device 220. For example, when the front area of the vehicle 100 is set to be the information request range, the processor 170 may transmit an information request signal to another vehicle located within a predetermined distance from the vehicle 100 in the forward direction.

In step S550, the processor 170 may receive information about an object (e.g. another vehicle) through the communication device 220. The information about the object may include information about the location of the object and information about the type of the object. For example, the information about the type of the object may include information about the type of a lane, which is classified as an object, or information about the type of another vehicle (e.g. a sedan, a bus, or a truck), which is classified as an object. Based on information about the type of another vehicle classified as an object, the processor 170 may estimate the size of the other vehicle.

In step S550, the processor 170 may further receive location information of another vehicle transmitting information. For example, the processor 170 may receive coordinate information and direction information of the other vehicle transmitting information. The processor 170 may further receive information about the location of the other vehicle transmitting information relative to the vehicle 100. Based on the location information of the other vehicle classified as an object and the information about the location of the other vehicle transmitting information relative to the vehicle 100, the processor 170 may convert the information about the location of the object with respect to the vehicle 100.

If there is infrastructure, the processor may receive data on the infrastructure as well as the information about the object.

The processor 170 may determine the quality of the information received in step S550 (S555). The processor 170 may determine whether the size of an error of the information received from the other vehicle is equal to or greater than a reference value. For example, the processor 170 may compare the location information of the object received from the other vehicle or the information about the type of the object with the information acquired by the sensor, which is included in the vehicle 10 and has not failed, and may determine whether the received information has an error.

The processor 170 may generate data on the object by fusing external data into sensing data generated by a sensor that has not failed among the plurality of sensors in the state in which power is supplied to the processor (S570). The processor 170 may use information recalculated based on the vehicle 10. The processor 170 may generate and provide planning data for travel to the safety zone. The processor 170 may transmit the planning data to another vehicle around the vehicle 10 through the communication device 220.

When it is determined that the camera among the plurality of sensors has failed, the receiving step (S550) may include receiving, by the at least one processor 170, image data from at least one of the infrastructure or the other vehicle through the communication device 220. In this case, the generating step (S570) may include converting, by the at least one processor 170, a viewpoint of the received image data into a viewpoint of the vehicle.

Meanwhile, when it is determined that the range sensor among the plurality of sensors has failed, the receiving step (S550) may include receiving, by the at least one processor 170, range data from at least one of the infrastructure or the other vehicle through the communication device 220. In this case, the generating step (S570) may include converting, by the at least one processor 170, a viewpoint of the received range data into a viewpoint of the vehicle.

Meanwhile, the generating step (S570) may include generating, by the at least one processor 170, motion planning data for moving the vehicle 10 to the safety zone based on the data on the object, and providing, by the at least one processor 170, the motion planning data to other electronic devices in the vehicle 10.

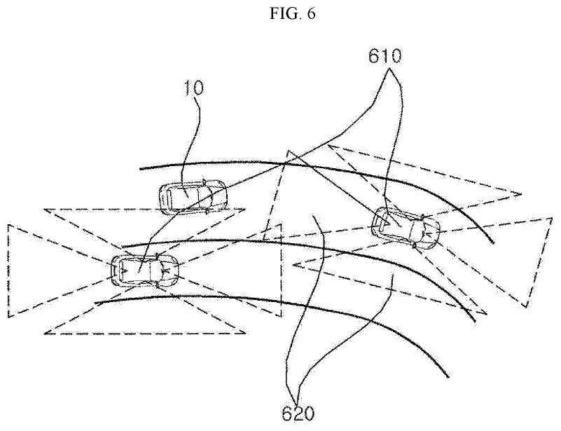

FIG. 6 is a view for explaining the operation of the electronic device according to the embodiment of the present invention.

Referring to FIG. 6, in the state in which at least one of the plurality of sensors fails, the electronic device 100 may receive data from other vehicles 610 and 620 through the communication device 220 using V2X communication. The data received from the other vehicles 610 and 620 may be data generated by sensors provided in the other vehicles 610 and 620.

When the camera among the plurality of sensors fails, the processor 170 may receive image data from the other vehicles 610 and 620. The processor 170 may receive data on the relative positional relationship between the vehicle 10 and the other vehicles 610 and 620 from the other vehicles 610 and 620. The processor 170 may convert the received image data into image data from a viewpoint of the vehicle 10 by applying the data on the relative positional relationship between the vehicle 10 and the other vehicles 610 and 620 to the received image data. The processor 170 may fuse the image data from a viewpoint of the vehicle 10 into the sensing data of a sensor (e.g. the range sensor) that has not failed among the plurality of sensors. The processor 170 may generate data on the object based on the fused data.

When the range sensor among the plurality of sensors fails, the processor 170 may receive range data from the other vehicles 610 and 620. The processor 170 may receive data on the relative positional relationship between the vehicle 10 and the other vehicles 610 and 620 from the other vehicles 610 and 620. The processor 170 may convert the received range data into range data from a viewpoint of the vehicle 10 by applying the data on the relative positional relationship between the vehicle 10 and the other vehicles 610 and 620 to the received range data. The processor 170 may fuse the range data from a viewpoint of the vehicle 10 into the sensing data of a sensor (e.g. the camera) that has not failed among the plurality of sensors. The processor 170 may generate data on the object based on the fused data.

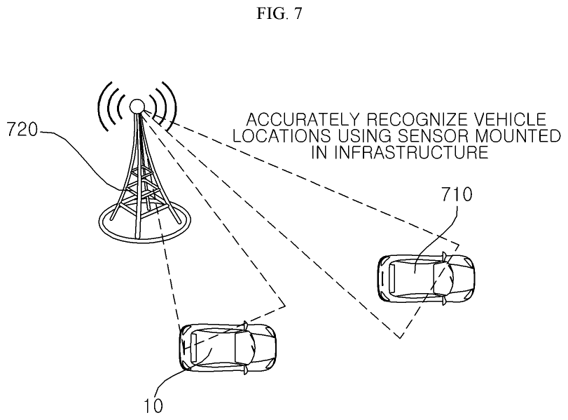

FIG. 7 is a view for explaining the operation of the electronic device according to the embodiment of the present invention.

Referring to FIG. 7, in the state in which at least one of the plurality of sensors fails, the electronic device 100 may receive data from infrastructure 720 through the communication device 220 using V2X communication. The data received from the infrastructure 720 may be data generated by a sensor provided in the infrastructure 720. Alternatively, the data received from the infrastructure 720 may be data generated by a sensor provided in another vehicle 710.

When the camera among the plurality of sensors fails, the processor 170 may receive image data from the infrastructure 720. The processor 170 may receive data on the relative positional relationship between the vehicle 10 and the infrastructure 720 from the infrastructure 720. The processor 170 may convert the received image data into image data from a viewpoint of the vehicle 10 by applying the data on the relative positional relationship between the vehicle 10 and the infrastructure 710 to the received image data. The processor 170 may fuse the image data from a viewpoint of the vehicle 10 into the sensing data of a sensor (e.g. the range sensor) that has not failed among the plurality of sensors. The processor 170 may generate data on the object based on the fused data.

When the range sensor among the plurality of sensors fails, the processor 170 may receive range data from the infrastructure 720. The processor 170 may receive data on the relative positional relationship between the vehicle 10 and the infrastructure 720 from the infrastructure 720. The processor 170 may convert the received range data into image data from a viewpoint of the vehicle 10 by applying the data on the relative positional relationship between the vehicle 10 and the infrastructure 710 to the received range data. The processor 170 may fuse the image data from a viewpoint of the vehicle 10 into the sensing data of a sensor (e.g. the camera) that has not failed among the plurality of sensors. The processor 170 may generate data on the object based on the fused data.

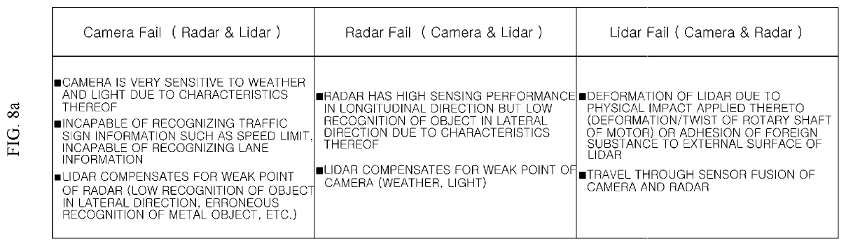

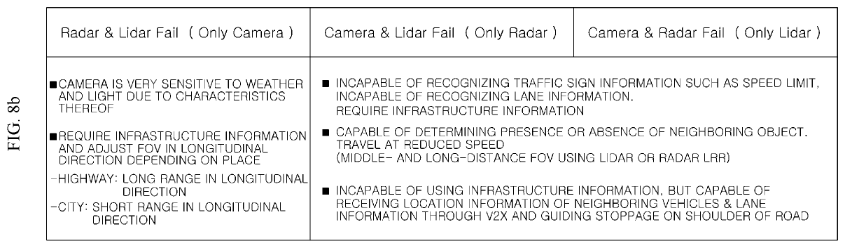

FIGS. 8a and 8b are views for explaining the operation of the electronic device according to the embodiment of the present invention.

Referring to FIG. 8a, sensors mounted in the vehicle 10 may fail due to physical damage thereto (e.g. damage or calibration error) or the limits thereof. If there are two sensors that have a complementary relationship therebetween, when any one sensor fails, it is possible to respond to the failure using information from infrastructure and neighboring vehicles. If there is no infrastructure, if there are no other vehicles around the vehicle 10, or if the state of received data is poor, an emergency light of the vehicle 10 may be turned on, and the vehicle 10 may decelerate, stop, and enter a standby state. In this case, the vehicle 10 may transmit sensor failure information and a warning message to neighboring vehicles.

A camera is characterized in that it is very sensitive to weather and light. A camera may fail due to backlight or sunlight shining near the exit of a tunnel. In addition, a camera may fail to recognize lanes or objects while driving at night in a region in which there is no light or while driving in the rain. When the camera fails, it is not capable of recognizing traffic signs or lanes. When the camera fails, a lidar may compensate for the weak point of a radar. The weak point of a radar, e.g. low recognition of objects in a lateral direction or erroneous recognition of a metal object, may be overcome by a lidar.

A radar is characterized in that the sensing performance in a longitudinal direction is excellent but the recognition of objects in a lateral direction is poor. When the radar fails, the weak point of the camera, which is affected by weather, light, or the like, may be compensated for by the lidar.

A lidar may fail when physical impacts are applied thereto or when foreign substances adhere to the external surface thereof. In this case, data acquired by the camera and data acquired by the radar may be used through sensor fusion.

Referring to FIG. 8b, in the state in which three types of sensors (a camera, a radar, and a lidar) are mounted in the vehicle 10, two types of sensors may fail. In this case, since only one sensor operates, it is required to maximize utilization of the data generated by infrastructure and neighboring vehicles. If there is no infrastructure, if there are no neighboring vehicles, or if the state of received data is poor, an emergency light of the vehicle 10 may be turned on, and the vehicle 10 may decelerate, stop, and enter a standby state. In this case, the vehicle 10 may transmit sensor failure information and a warning message to neighboring vehicles.

When the radar and the lidar fail, the processor 170 may adjust the field of view (FOV) of the camera. For example, the processor 170 may adjust the longitudinal-direction FOV to be long when the vehicle 10 is traveling on a highway, and may adjust the longitudinal-direction FOV to be short when the vehicle 10 is traveling on a road in a city.

When the radar and the lidar fail, reception of data from an external device is required. The processor 170 may control the vehicle to remain in the traveling lane, and may receive data from an external device through the communication device 220. Based on time information, weather information, and location information of the vehicle 10, the processor 170 may reduce the speed of the vehicle 10 in a rainy area, a foggy area, a backlight area, and a tunnel exit area so as to verify information about objects ahead of, behind, and beside the vehicle 10. If there are no other vehicles around the vehicle 10, an emergency light of the vehicle 10 may be turned on, and the vehicle 10 may decelerate, stop, and enter a standby state on the shoulder of the road through communication with the external device.

When the camera and the lidar fail or when the camera and the radar fail, it is impossible to recognize traffic sign information (e.g. a speed limit), and thus reception of data from an external device is required. Since one among the radar and the lidar that has not failed is capable of determining the presence or absence of neighboring objects, the vehicle 10 may travel at a reduced speed. In this case, the processor 170 may adjust the FOV of the lidar or the radar. The processor 170 may receive location information and lane information of other vehicles from an external device. The processor 170 may generate a control signal for stopping the vehicle 10 on the shoulder of the road based on the data generated by the lidar or the radar and the data received from the external device.

Meanwhile, in the state in which three types of sensors (a camera, a radar, and a lidar) are mounted in the vehicle 10, all of the three sensors may fail. In this case, since there is no usable sensor, it is required to maximize utilization of infrastructure so as to use the information about neighboring vehicles. If there is no infrastructure, if there are no neighboring vehicles, or if the state of data received from neighboring vehicles is poor, an emergency light of the vehicle 10 may be turned on, and the vehicle 10 may decelerate, stop, and enter a standby state. In this case, the vehicle 10 may transmit sensor failure information and a warning message to neighboring vehicles.

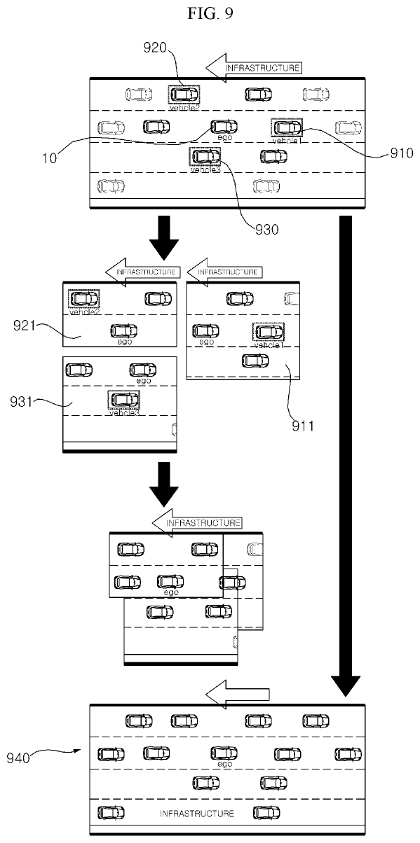

FIG. 9 is a view for explaining the operation of the electronic device according to the embodiment of the present invention.

Referring to FIG. 9, when a global positioning system (GPS) sensor in the vehicle 10 fails, the processor 170 may generate a local map of the vehicle 10 based on local maps received from other vehicles 910, 920 and 930 around the vehicle 10. The GPS sensor may be included in the location data generating device 280.

The processor 170 may receive first local map data generated by a first other vehicle 910 from the first other vehicle 910. A first local map 911 may include information about the absolute location of the vehicle 10, information about the speed of the vehicle 10, information about the locations/speeds of other vehicles around the vehicle 10, lane information, infrastructure information, and so on. The processor 170 may receive second local map data generated by a second other vehicle 920 from the second other vehicle 920. A second local map 921 may include information about the absolute location of the vehicle 10, information about the speed of the vehicle 10, information about the locations/speeds of other vehicles around the vehicle 10, lane information, infrastructure information, and so on. The processor 170 may receive third local map data generated by a third other vehicle 930 from the third other vehicle 930. A third local map 931 may include information about the absolute location of the vehicle 10, information about the speed of the vehicle 10, information about the locations/speeds of other vehicles around the vehicle 10, lane information, infrastructure information, and so on.

Data on each of the first local map 911, the second local map 921, and the third local map 931 may contain errors. The processor 170 may correct such errors based on the absolute location of the infrastructure, lane information, and the like.

The processor 170 may generate a local map 940 of the vehicle 10 by combining the first local map 911, the second local map 921, and the third local map 931.

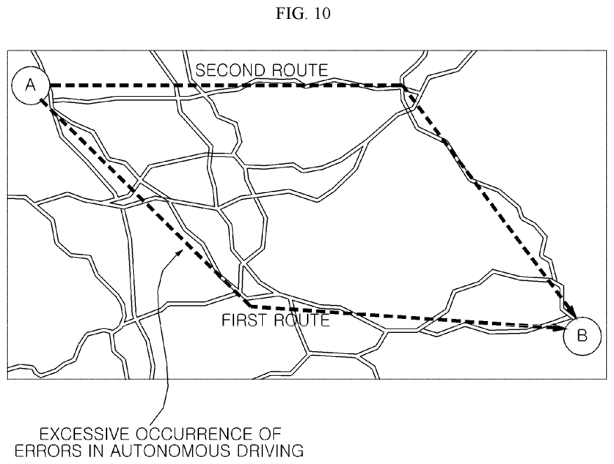

FIG. 10 is a view for explaining the operation of the electronic device according to the embodiment of the present invention.

Referring to FIG. 10, the system may include a plurality of vehicles and infrastructure. The plurality of autonomous vehicles may transmit error-related data to the infrastructure while traveling. The error-related data may include error location data and error situation data.

The infrastructure may organize the received error-related data. The infrastructure may verify an error occurrence area in which an error occurs a predetermined number of times or more. The error occurrence area may be an area in which there is no lane or in which the curvature of a curved road is equal to or greater than a reference value. When a first vehicle enters the error occurrence area, the infrastructure may transmit a warning message to the first vehicle.

Meanwhile, the infrastructure may provide the error-related data to a vehicle manufacturer, and the vehicle manufacturer may analyze the data to use the same to improve the vehicle performance. The infrastructure may provide error-related data to a system administrator to help determine the need for infrastructure reinforcement in the error occurrence area. In autonomous driving global route planning, the error occurrence area may be excluded from the route.

The autonomous vehicle may generate a route while excluding the error occurrence area when generating the route.

The aforementioned present invention may be implemented as computer-readable code stored on a computer-readable recording medium. The computer-readable recording medium may be any type of recording device in which data is stored in a computer-readable manner. Examples of the computer-readable recording medium include a Hard Disk Drive (HDD), a Solid-State Disk (SSD), a Silicon Disk Drive (SDD), Read-Only Memory (ROM), Random-Access Memory (RAM), CD-ROM, magnetic tapes, floppy disks, optical data storage devices, carrier waves (e.g. transmission via the Internet), etc. In addition, the computer may include a processor and a controller. The above embodiments are therefore to be construed in all aspects as illustrative and not restrictive. It is intended that the present invention cover the modifications and variations of this invention provided they come within the scope of the appended claims and their equivalents.

1. An electronic device for a vehicle, comprising:
a power supplier supplying power;
an interface exchanging data with a communication device; and
a processor configured to:
receive external data from at least one external device through the communication device upon determining that at least one of a plurality of sensors has failed in a state in which the power is supplied to the processor, generate data on an object by fusing the external data into sensing data generated by a sensor that has not failed among the plurality of sensors.

2. The electronic device of claim 1, wherein the processor is configured to:
upon determining that a camera among the plurality of sensors has failed, receive image data from at least one of infrastructure or another vehicle through the communication device, and convert a viewpoint of the received image data into a viewpoint of a vehicle, and
upon determining that a range sensor among the plurality of sensors has failed, acquire range data from at least one of infrastructure or another vehicle through the communication device, and convert a viewpoint of the received range data into a viewpoint of the vehicle.

3. The electronic device of claim 1, wherein the processor is configured to:
set an information request range based on a direction in which a sensor that has failed is oriented, and
transmit an information request signal to at least one first other vehicle located within the set information request range.

4. The electronic device of claim 3, wherein the processor is configured to:
receive information about a type of a second other vehicle, location information of the second other vehicle, and relative location information of a vehicle and the first other vehicle from the first other vehicle,
estimate a size of the second other vehicle based on the information about the type of the second other vehicle, and
convert the location information of the second other vehicle with respect to the vehicle based on the location information of the second other vehicle and the relative location information.

5. The electronic device of claim 1, wherein the processor wherein the processor is configured to provide a control signal such that a vehicle travels at a speed set according to a type of sensor that has failed among the plurality of sensors.

6. A method of operating an electronic device for a vehicle, the method comprising:
determining, by at least one processor, whether at least one of a plurality of sensors has failed in a state in which power is supplied to the at least one processor;
upon determining that the at least one of a plurality of sensors has failed, receiving, by the at least one processor, external data from at least one external device through a communication device in a state in which power is supplied to the at least one processor; and
generating, by the at least one processor, data on an object by fusing the external data into sensing data generated by a sensor that has not failed among the plurality of sensors in a state in which power is supplied to the at least one processor.

7. The method of claim 6, wherein the receiving comprises:
upon determining that a camera among the plurality of sensors has failed, receiving, by the at least one processor, image data from at least one of infrastructure or another vehicle through the communication device, and
wherein the generating comprises:
converting, by the at least one processor, a viewpoint of the received image data into a viewpoint of a vehicle.

8. The method of claim 6, wherein the receiving comprises:
upon determining that a range sensor among the plurality of sensors has failed, receiving, by the at least one processor, range data from at least one of infrastructure or another vehicle through the communication device, and
wherein the generating comprises:
converting, by the at least one processor, a viewpoint of the received range data into a viewpoint of a vehicle.

9. The method of claim 6, wherein the receiving comprises:
setting, by the at least one processor, an information request range based on a direction in which a sensor that has failed is oriented; and
transmitting, by the at least one processor, an information request signal to at least one first other vehicle located within the set information request range.

10. The method of claim 9, wherein the receiving further comprises:
receiving information about a type of a second other vehicle, location information of the second other vehicle, and relative location information of a vehicle and the first other vehicle from the first other vehicle;
estimating a size of the second other vehicle based on the information about the type of the second other vehicle; and
converting the location information of the second other vehicle with respect to the vehicle based on the location information of the second other vehicle and the relative location information.

11. The method of claim 6, further comprising:
providing a control signal such that a vehicle travels at a speed set according to a type of sensor that has failed among the plurality of sensors.
